(19) United States
(12) Patent Application Publication
(10) Pub. No.: US 2004/0031035 A1
(43) Pub. Date: Feb. 12, 2004

(54) Workflow processing scheduler

(76) Inventors: Simon Shiu, Bristol (GB); Marco Casassa Mont, Bristol (GB); Adrian Baldwin, Bristol (GB); Andrew Patrick Norman, Bristol (GB)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,776

(22) Filed: Apr. 17, 2003

(30) Foreign Application Priority Data
Apr. 19, 2002 (GB) 0208966.2

(51) Int. Cl. G06F 9/00

(52) U.S. Cl. 718/102

(57) ABSTRACT

An operating system for processing multiple tasks, the operating system comprising means for generating the multiple tasks including data indicating a time at which or by which (and/or a frequency at which and/or one or more events in response to which) the task should be processed, means for associating time stamp data with the tasks, said time stamp data being indicative of the date and/or time at which the respective tasks were generated, and means for receiving said tasks for processing at a particular time, determining from the associated time stamp for each task the date and/or time at which said task was generated, determining whether or not the processing of said task at said particular time is consistent with one or more predetermined operating system policies, and causing said task to be processed at said particular time only if such processing is determined to be consistent with said operating system policies. The addition of timestamp data to the tasks allows the system to check that the time at which the task was created and then given to a scheduling system for processing corresponds with that expected of such a task (according to company policy and the nature of the task to be processed).

### FIELD OF THE INVENTION

This invention relates to a method and apparatus for processing of scheduled tasks within an operating system or application.

### BACKGROUND TO THE INVENTION

There are several situations in which an operating system or application may be required to manage data and process tasks over a relatively long period of time, typically several years. For example, a long-term electronic document storage system.

The management of electronic documents is relatively complex in that the integrity and confidentiality of such electronic documents must be maintained whilst ensuring that documents, say stored 10 years ago, are readable on the latest generation of computer systems. As such, digital records tend to be encrypted prior to storage so as to prevent unauthorised access to their contents.

Digital records can be encrypted and decrypted using cryptography, the branch of applied mathematics that concerns itself with transforming digital documents into seemingly unintelligible forms and back again. One known type of cryptography uses a methodology which employs an algorithm using two different but mathematically related “keys”, one for transforming data into a seemingly unintelligible form, and one for returning the message to its original form. Although the two keys are mathematically related, if the document storage system is designed and implemented securely, it should be computationally infeasible to derive the private key from knowledge of the public key. Further, a digital record may be digitally signed for added authenticity. Digital signature creation uses a hash value derived from, and unique, to both the signed record and a given private key. Such a hash value is created using a hash function which is an algorithm which creates a digital representation (i.e. hash value) of a standard length which is usually much smaller than the digital record it represents but nevertheless substantially unique to it. Any change to the record should invariably produce a different hash value when the same hash function is used, i.e. for the hash value to be secure, there must be only a negligible possibility that the same digital signature could be created by the combination of any other message or private key. To associate a key pair with a prospective signer (to confirm their integrity), a certification authority issues a certificate, which is an electronic record which lists a public key as the “subject” of a certificate and confirms that the prospective signer listed in the certificate holds the private key.

However, private and public keys are simply n-bit numbers and, as the computational and processing ability of modern systems increases over time, so the number of bits required to be used for such keys must be increased in order to ensure that a “trial and error” approach, which could otherwise be used to decrypt a piece of data which has been encrypted using a private key (by simply trying all of the possible combinations of the respective public key) remains computationally infeasible according to up-to-date processor abilities. Thus, the digital signature applied to a digital record may need to be updated periodically in order to ensure that the authenticity of the record is maintained over a long period of time. Further, digital certificates are only valid for a predetermined period of time, typically one year, and may need to be renewed regularly.

Another issue to be considered in the long-term storage of digital documents is the rendering tool used to create such documents. Rendering tools, such as word processing software packages and the like, tend to be updated and new versions issued on a regular basis. Thus, the rendering tool used to create a document, say, 10 years ago would now be very out-of-date such that the document is no longer readable using current software and equipment. Thus, some consideration needs to be given to the re-versioning of such documents so that they are still readable many years after their creation and storage.

Thus, there are a number of critical issue which need to be considered in the implementation of a long-term digital document storage system, as follows:

ensuring that records are not unintentionally lost, even if they are stored for decades or more;

maintaining and ensuring the integrity of records;

controlling the confidentiality of stored records;

maintaining ownership and/or access control details for records;

preserving the context of a record (e.g. an e-mail created 8 years ago will be fairly meaningless without an indication of the conversation of which it was a part);

preserving trust properties associated with a record.

The significance of these issues with respect to any particular document or set of documents will be dependent upon the length of time it is required to be stored, the level of confidentiality/importance is associated with it, the trust properties associated with it, etc. Therefore, the management of documents or sets of documents will vary according to these and other variables. As such, many systems of this type might include some form of data management strategy which defines and generates tasks to be performed in respect of stored data over a predetermined period of time (e.g. renewing the digital signature and or digital certificate periodically, updating the version of the rendering tool as required, etc.).

In most modern operating systems and applications, the management of performance of multiple processing tasks is carried out by a scheduler, which receives details of tasks to be performed and a trigger to cause said task to be performed at the required time. A scheduler may be hardware- and/or software-implemented, and its functionality in respect of each different type of operating system will vary according to the tasks to be carried out. However, in general, the specification of a particular scheduler tends to assume a set of resources and a set of “customers” to be serviced by those resources according to a certain policy (as defined in the above-mentioned data management strategy, for example). Thus, in the long-term document storage system referred to above, the scheduler specification will assume a predetermined set of resources available to carry out a number of tasks in respect of the stored data, and will be designed to schedule the performance of such tasks in the most efficient manner possible, taking into account considerations such as the level of priority of a task, etc. as may be defined by the data management strategy.

In the case of a long-term electronic document storage system or the like, the scheduler may be required to perform two roles, i.e. recording tasks or ‘work items’ to be performed in respect of stored data (based on time or event triggers), and performing these tasks when triggered to do so. In this respect, such a scheduler is similar to many workflow type schedulers. However, in this type of operating system, there could be a long period of time between a work item being recorded with the scheduler and when the work item is triggered to be performed.

As a result, the time window for doing any one task is likely to be larger, thus giving more scope for reporting problems and/or trying again.

However

there is more danger that the work item and/or its trigger will be lost or corrupted;

authentication of work items at the time of processing is more difficult;

In other words, the present invention is related to the production, and processing, of scheduled tasks (or ‘work items’). It is assumed that a task creation module will create work items which will then be queued until it is time for them to be processed by another (consuming) module (or an event occurs which triggers them to be processed by another (consuming) module). The technical problem to be addressed is to ensure that the consuming module only processes legitimate work items, i.e. those created by legitimate creation modules under the correct conditions.

We have now devised an arrangement which seeks to overcome these problems and provides an operating system or application having a scheduler (or scheduling function) which is of improved robustness over scheduling functions known in the art.

### SUMMARY OF THE INVENTION

Also in accordance with the present invention, there is provided a method of processing multiple tasks within an operating system or application, the method comprising the steps of generating said multiple tasks and including therein data indicating a time at which or by which (and/or a frequency at which and/or one or more events in response to which) said task should be processed, generating time stamp data to be associated with at least one of said tasks indicative of the date and/or time at which the at least one respective task was generated, receiving said tasks for processing at a particular time, determining from the associated time stamp data for each task the date and/or time at which said task was generated, determining whether or not the processing of said task at said particular time is consistent with predetermined operating system or application policies, and causing said task to be processed at said particular time only if such processing is determined to be consistent with said operating system or application policies.

Thus, the present invention introduces the concept of including an indication of the time of creation of a processing task such that the system, or application (when it is asked to process the task) can check that the time at which the task was apparently created corresponds with the time at which the system, or application would have expected such a task to have been created.

In a preferred embodiment of the present invention, there may be provided a plurality of means for generating said tasks, in which case the system, or application preferably also includes means for adding or associating data thereto indicating the originating generating means for each task, the operating system further comprising means for checking that the originating generating means of a task is a legitimate one.

In one embodiment of the invention, the operating system, or application may comprise one or more task generation modules, one or more schedulers and one or more consuming modules, said one or more schedulers being arranged to determine from the associated time stamp data for each task the date and/or time at which said task was generated, determine whether or not the processing of said task at said particular time is consistent with predetermined operating system, or application policies, and cause said task to be processed at said particular time only if such processing is determined to be consistent with said operating system, or application policies.

In this case, the time stamp data is beneficially generated and associated with a task via said one or more task generation modules.

Alternatively, the operating system, or application may comprise one or more task generation modules, one or more schedulers and one or more consuming modules, said one or more consuming modules being arranged to determine from the associated time stamp data for each task the date and/or time at which said task was generated, determine whether or not the processing of said task at said particular time is consistent with predetermined operating system, or application policies, and cause said task to be processed at said particular time only if such processing is determined to be consistent with said operating system, or application policies.

In this case, the time stamp data is beneficially generated and associated with a task via said one or more schedulers.

In either case, the time stamp data is preferably provided and/or authenticated by a third party, and may be, for example, digitally signed by said third party. A standard form of timestamp is known as RFC #3161, further details of which can be found at LHP:

www.ietf.org/rfc.html

As stated above, the tasks may have associated therewith authentication data indicative of their origin within said operating system, or application and the authentication data may include a digital signature.

In a further aspect, the invention provides a computer system programmed for scheduling task execution, wherein the computer system is programmed to generate tasks and to associate with generated tasks criteria for processing said tasks and data representing the time of generation of said tasks, and wherein the computer system is programmed to carry out said tasks in accordance with the associated criteria only after evaluation of the time of generation data.

In a still further aspect, the invention provides a method of generating and processing tasks in a computer system, comprising: generating a task, and associating with the task one or more criteria for processing the task and a time of generation datum representing the time of generation of the task; identifying when the one or more criteria for processing the task have been met; evaluating the time of generation datum to determine whether it is appropriate to process the task; and processing the task if the evaluation step is successful.

### BRIEF DESCRIPTION OF THE DRAWINGS

An embodiment of the present invention will now be described by way of example only and with reference to the accompanying drawings, in which:

FIG. 1 is a schematic diagram illustrating a high level view of the architecture of an active storage system according to an exemplary embodiment of the present invention;

FIG. 2 is a schematic diagram illustrating an overview of a design for an individual scheduler for use in a system according to an exemplary embodiment of the present invention;

FIGS. 3a and 3b are schematic diagrams illustrating the scheduler database structure in accordance with an exemplary embodiment of the present invention, respectively before and after a work item has been processed; note that the schedule data is replicated to increase/improve survivability of the arrangement; and

FIG. 4 is a schematic flow diagram illustrating a method of generating and processing tasks in a computer system, in attendance with an exemplary embodiment of the present invention.

### DETAILED DESCRIPTION OF THE INVENTION

Two exemplary embodiments of the present invention will first be briefly described prior to a more detailed description of various aspects thereof being given.

In the following examples, a work item is assumed to be a data structure containing information about when a specific task should be performed, and the creation module (i.e. the module which created the work item) is assumed to have a private key for digitally signing. Also for the purposes of the following example, the scheduler is assumed to be a queuing program that passes packages on when certain time conditions (interpretable from the work item) are met.

Referring to FIG. 4 of the Drawings

The creating module produces a work item at step 400 (and a hash value of the rules used to create the work item may be generated) and associates therewith one or more criteria for processing the work item at step 402;

The creating module digitally signs (using its private key) the hash value of the work item;

A third party timestamping authority digitally signs a hash value of the signature (step 404);

All three items are packaged and stored (step 406) with a scheduler until it is time to process the work item;

A continuous loop is employed to search stored tasks (step 408) to determine (step 410) if there are any time-triggered tasks;

The package relating to a time-triggered task is then passed to the consuming module;

The consuming module verifies the timestamping signature, and the creating module signature (by knowledge of the respective private keys);

The consuming module verifies (step 412) that the time of the timestamp corresponds with information held in company policy (or data management strategy) and in the work item;

Assuming that all of the verifications went well, the consuming module does the work specified in the work item (step 414).

Alternatively, the Time Authentication could be added by the Scheduler, i.e

The creating module produces a work item;

The creating module digitally signs (using its private key) a hash value of the work item;

Both are packaged and sent to the scheduler;

A third party timestamping authority signs a hash value of the package;

When the time to process the task is reached, the scheduler passes the package and timestamp to the consuming module;

The consuming module verifies the timestamping signature and the creating module signature;

The consuming module verifies that the time of the timestamp corresponds with information held in company policy and in the work item;

Assuming all verifications went well, the consuming module does the work specified in the work item.

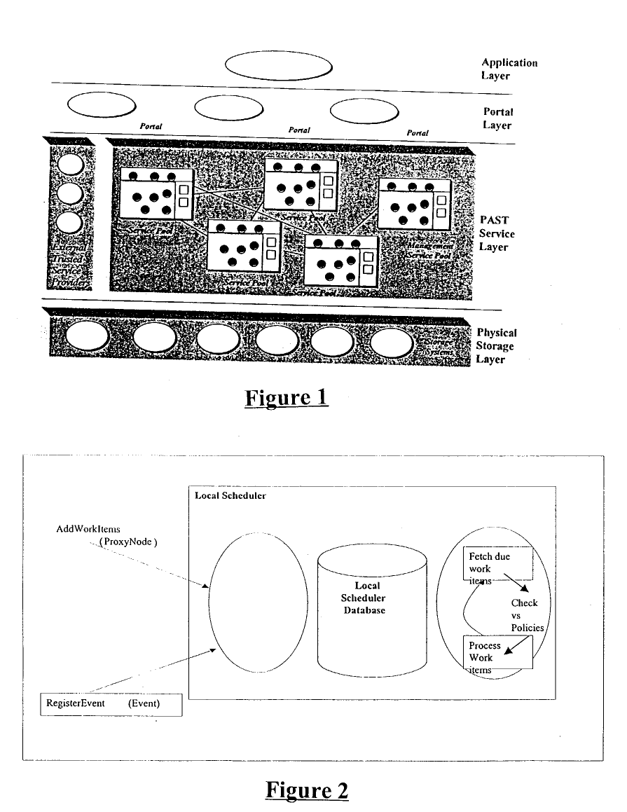

FIG. 1 of the drawings shows a high level view of the architecture of an active storage system according to an exemplary embodiment of the present invention. As shown, the architecture is organised into three main layers:

The Portal Layer is the gateway to access the system services from the external world.

The Service Layer is the layer that supplies the electronic records storage services, management services and longevity services. This layer is populated by multiple distributed ‘service pools’, each of them running a similar set of basic services. Such service/pools will generally be organised to be “survivable” for the long term (i.e. decades), and the basic services referred to above will include task creation, the scheduler and the consuming modules.

The Physical Storage Layer is the level where electronic records are physically stored.

This level may be external to the storage system itself, in the sense that multiple external providers can potentially supply these services.

A scheduler for use in this exemplary embodiment of the present invention may be in the form of a ‘distributed scheduler’, in the sense that it comprises a set of individual schedulers from amongst the service pools. Each scheduler might be called in two ways:

to allow work items (i.e. tasks to be performed in respect of the stored data) to be registered with the overall scheduler; and

to allow external events to be registered with the overall scheduler (thus triggering any work items waiting for such an event).

FIG. 2 is a schematic diagram illustrating an overview of a design for an individual scheduler. As shown, each scheduler includes a local scheduler database containing triggers for each work item registered, and an ongoing loop that checks the local database for any time-triggered work items that are due to be processed, and processes them.

However, the scheduler does not store the work items. Work items are programmatically executable items which specify either long-term activities, which need to be done with respect to an electronic record, or events which must be properly managed when they occur. Because of their nature, they need to be stored in a ‘survivable’ way, wherein ‘survivability’ can be defined as the ability to of a computing system to provide essential services in the presence of attacks and failures, and/or its ability to recover full services in a timely manner.

In order to facilitate this, in this exemplary embodiment of the present invention, work items are stored within a ‘proxy node’ associated to the electronic record. Its survivability is ensured by the replication of the proxy node within multiple indexes randomly chosen by the system. The term ‘proxy node’ is employed herein to mean a data structure containing metadata about a stored electronic record, which metadata may include the name of the electronic record, information about the electronic record replicas (e.g. their locations, encryption keys, etc.), work items, and the last date and time of modification of the proxy node. Each proxy node is assigned a unique ‘name’ by the system.

It will be appreciated that work items need to be executable when required. As such, a reference to the work items is stored within schedulers (in multiple service pools) along with their execution time. The scheduler is designed to take care of executing work items according to the constraints it specifies.

Thus, an individual scheduler registers a work item by storing triggers across a random set of scheduler databases. Each work item contains a token that is unique within its proxy node. An example of a token format is illustrated below:

WorkItemToken>
<WorkItem.workitem.xml/WorkItem>
// reference to the actual workitem
<WorkItemType>Deletion</WorkItemType>
<WorkItemPolicies>workitempolicies.xml></WorkItemPolicies
// e.g. corporate policies relating to this document, e.g. if it's a receipt of
dept. X then certain policy files will be referenced
<Originator>AgreementInterpreter176</Originator>
// the task creation module
<OriginatorsSignature>signature</OriginatorSignature>
// digital signature of the originator
<Timestamp>timestampdata.xml</Timestamp>
// 3^{rd} party timestamp of the data, e.g. as per RFC 316
1
</WorkItemToken>

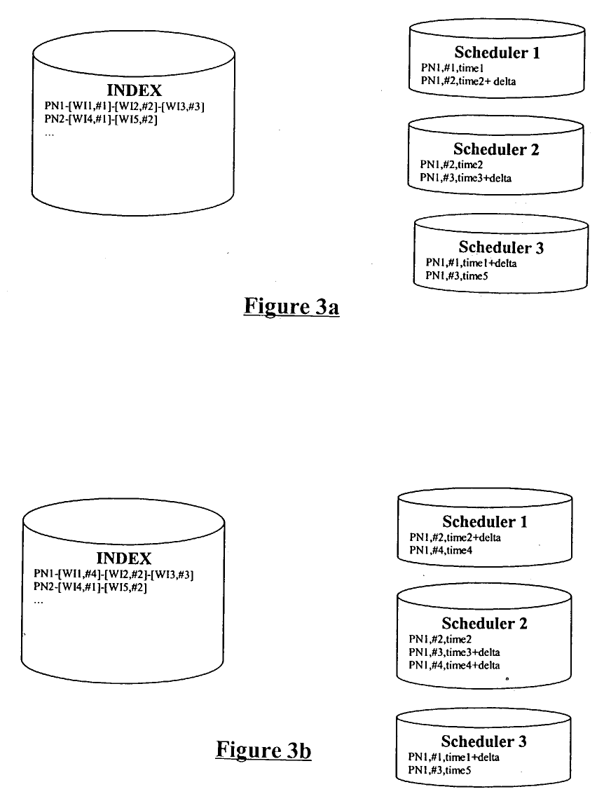

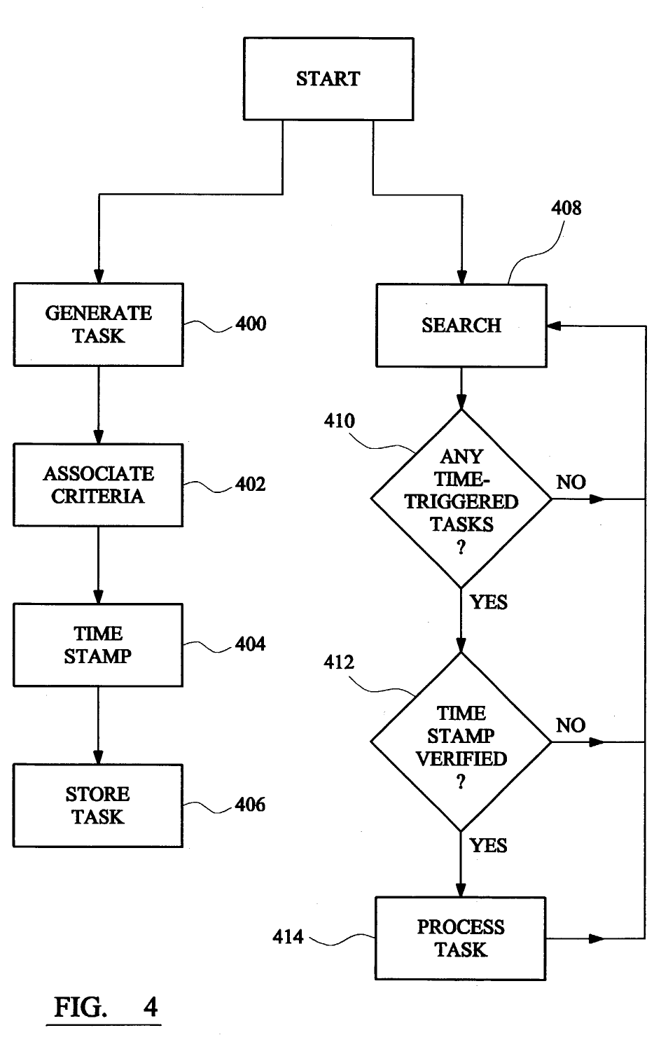

The proxy node name and token are used as keys to link the triggers to original work items. Referring to FIG. 3a of the drawings, which illustrates the scheduler database structure used in this exemplary embodiment of the present invention, in order to process a trigger, the scheduler fetches the original work item, authenticates it (as described in more detail below), and passes it on to the relevant services for processing. Once the task has been successfully performed, the work item is removed from the respective proxy node (so that remaining triggers do not attempt to perform the task). If the work item needs to be repeated (e.g. an annual timestamp), then the token is changed (thus preventing remaining triggers from finding it), and new triggers are set up by the scheduler.

Thus, if the work item will need to be repeated, and the first trigger successfully performed it, the new states might be as shown in FIG. 3b. Note that the token has changed to “#4”, schedulers 1 and 2 have triggers with the correct token, and scheduler 3 has an incorrect token which will be removed when it triggers. The processes for event-triggered items is very similar, except that they are triggered by external events being registered with a scheduler, which in turn triggers the checking of a larger set of triggers for processing. Each of the distributed work items is triggered at a different time (these differences in time are depicted as “#'s” in FIGS. 3a and 3b). This pseudo replication of triggers adds robustness to the systems as the triggers will not try to do the work at the same time, and the fact that the item disappears means that it won't be a problem when the later triggers are set off.

Before processing a work item, the scheduler in this exemplary embodiment of the present invention verifies that it is legitimate, i.e created directly from a data management strategy authorised and/or defined legitimately, and an example of the operation of a suitable algorithm for this purpose is illustrated below:

1. Load the policies that apply (say the corporate receipt policy applies).

2. The receipt policy suggests that this document should be destroyed between 6-7 years of archiving.

3. Check via the timestamp, the time the work item was produced. If it was between 6-7 years ago, then this is ok. Else a message is sent to an administrator.

4. Further checks.

As explained above, however, problems can arise in the case of systems such as long-terms storage systems in that there is so much time between creation of a work item and its processing, that there is a lot of scope for creating forged work items.

This problem is overcome in the present invention by including in (or associating with) each work item a third-party generated timestamp. The scheduler is adapted to determine the expected creation time of a work item (derived from the data management strategy or from the type of task requested) and/or the expected time of that work item being triggered and, by comparing this information with the third-party generated timestamp of the work item itself, it can determine the legitimacy of the triggered work item. This serves as an extra check that can be performed before doing the task.

For example, the work item may be to delete a document in 2 years time. The work item creation module should produce a token which proves that it was in fact that module which produced the work item, and the token contains time authentication (e.g. a time stamp from a third party provider) to indicate when it was produced. When the scheduler receives the work item (in response to a trigger), it can check the token to validate that it was in fact produced in accordance with the data management strategy and that it was created at the appropriate time (i.e. it fits the deletion policy that such a work item would be created 2 years prior to deletion). Only if the work item is satisfactorily authenticated will it be processed, otherwise, the system may be arranged to generate an alert, ignore the work item altogether, or cause some other failure in the system to alert the system manager.

Using time in the authentication makes it much more difficult for an attacker to perpetrate the system. Even if such an attacker were to break into the system, they would still be limited to creating work items and tokens which conform to the scheduler's (or consuming module's) expectations, i.e. in the above example, there must be a two-year delay before they have an effect. Moreover, the token created does not necessarily need special protection, as it cannot in any event be misused by the wrong people/process.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. An operating system or application for processing multiple tasks, the operating system, or application, being arranged to generate said multiple tasks including data indicating when said task should be processed, associate time stamp data with said tasks, said time stamp data being indicative of the date and/or time at which the respective tasks were generated, and to receive said tasks for processing at a particular time, determine from the associated time stamp for each task the date and/or time at which said task was generated, determine whether or not the processing of said task at said particular time is consistent with one or more predetermined operating system, or application policies, and cause said task to be processed at said particular time only if such processing is determined to be consistent with said operating system, or application policies.

2. An operating system or application according to claim 1, comprising one or more task generation modules, one or more schedulers and one or more consuming modules, said one or more schedulers being arranged to determine from the associated time stamp data for each task the date and/or time at which said task was generated, determine whether or not the processing of said task at said particular time is consistent with predetermined operating system, or application policies, and cause said task to be processed at said particular time only if such processing is determined to be consistent with said operating system, or application policies.

3. An operating system or application according to claim 1, comprising one or more task generation modules, one or more schedulers and one or more consuming modules, said one or more consuming modules being arranged to determine from the associated time stamp data for each task the date and/or time at which said task was generated, determine whether or not the processing of said task at said particular time is consistent with predetermined operating system, or application policies, and cause said task to be processed at said particular time only if such processing is determined to be consistent with said operating system, or application policies.

4. An operating system or application according to claim 3, wherein the times at which each of a plurality of tasks are processed are offset by some predetermined amount.

5. An operating system or application according to claim 2, wherein said time stamp data is generated and associated with a task via said one or more task generation modules.

6. An operating system or application according to claim 3, wherein said time stamp data is generated and associated with a task via said one or more schedulers.

7. An operating system or application according to claim 1, wherein said time stamp data is provided and/or authenticated by a third party.

8. An operating system application according to claim 7, wherein said time stamp data is digitally signed by said third party.

9. An operating system or application according claim 1, wherein said tasks have associated therewith authentication data indicative of their origin within said operating system.

10. An operating system or application according to claim 9, wherein said authentication data includes a digital signature.

11. A method of processing multiple tasks within an operating system or application the method comprising the steps of generating said multiple tasks and including therein data indicating when said task should be processed, generating time stamp data to be associated with at least one of said tasks indicative of the date and/or time at which the at least one respective task was generated, receiving said tasks for processing at a particular time, determining from the associated time stamp data for each task the date and/or time at which said task was generated, determining whether or not the processing of said task at said particular time is consistent with predetermined operating system, or application policies, and causing said task to be processed at said particular time only if such processing is determined to be consistent with said operating system, or application policies.

12. A computer system programmed for scheduling task execution, wherein the computer system is programmed to generate tasks and to associate with generated tasks criteria for processing said tasks and data representing the time of generation of said tasks, and wherein the computer system is programmed to carry out said tasks in accordance with the associated criteria only after evaluation of the time of generation data.

13. A method of generating and processing tasks in a computer system, comprising:
generating a task, and associating with the task one or more criteria for processing the task, and a time of generation datum representing the time of generation of the task;
identifying when the one or more criteria for processing the task have been met;
evaluating the time of generation datum to determine whether it is appropriate to process the task; and
processing the task if the evaluation step is successful.

14. A method as claimed in claim 13, comprising scheduling a task for processing according to the one or more criteria, and evaluating the time of generation datum when the task is scheduled for processing.

17. A method as claimed in claim 16, wherein a task scheduled for processing is given a task identity.

18. A method as claimed in claim 17, wherein a task is scheduled for a plurality of different times under the same task identity, but when the task is processed it becomes unavailable for processing under that task identity.

19. A method as claimed in claim 16 or 17, wherein a task scheduled for repeated processing is given discrete task identities for each processing of the task.
